(19) United States
(12) Patent Application Publication
(10) Pub. No.: US 2019/0090312 A1
(43) Pub. Date: Mar. 21, 2019

(54) NOVEL METHOD AND APPARATUS FOR REMOTELY CONTROLLING ELECTRONIC DEVICES

(71) Applicant: Ziming Zhou, Cupertino, CA (US)

(72) Inventor: Ziming Zhou, Cupertino, CA (US)

(21) Appl. No.: 15/999,870

(22) Filed: Aug. 23, 2018

Related U.S. Application Data
(60) Provisional application No. 62/605,952, filed on Sep. 5, 2017.

(51) Int. Cl. H04W 88/12; H04W 88/08; H04W 76/15; H04W 72/04

(52) U.S. Cl. CPC H04W 88/12; H04W 88/085; H04W 84/12; H04W 72/0446; H04W 76/15

(57) ABSTRACT

Disclosed herein are methods and apparatus for remotely controlling electronic devices using IEEE802.11 wireless technology.

### CROSS-REFERENCE TO RELATED APPLICATION

This application claims the benefit of U.S. Provisional Application No. 62/605,952, filed Sep. 5, 2017; the content of which is incorporated herein by reference in its entirety.

### FIELD

Embodiments of the invention relate generally to wireless communication.

### BACKGROUND

Remote controllers allow users to remotely control electronic devices. Improved remote controllers are needed.

### SUMMARY

Many of today's home electronics and industrial devices have IEEE802.11 wireless functionalities built in them. Provided herein are remote controllers based on IEEE802.11 WLAN technology. Compared to traditional infrared (IR) based remote controllers, the IEEE802.11 WLAN based remote controllers have advantages of not requiring line of sight operation and not requiring additional silicon for receiving remote control signals if the device being remote controlled has 802.11 wireless functionalities built in. Compared to other IEEE802.11 WLAN based remote controllers currently available on the market, the remote controllers described herein have advantages of having better reliability, lower latency, and being able to remotely control multiple devices simultaneously.

Accordingly, in some aspects, presented herein is a novel method and device of remote controlling using IEEE802.11 wireless technology.

In some embodiments, provided is a method of remote controlling home electronics and industrial devices, such as TVs, set top boxes, DVD players, video games, speakers, remote control cars, telephones, cell phones, computers, laptops, printers, paper shredders, lights, appliances (e.g., refrigerators, washers, dryers, ovens, microwave ovens, dishwashers, air conditioners (cooling and/or heating)), etc. In some embodiments, the remote controller sends remote controlling messages by transmitting IEEE802.11 layer 2 multicast frames and the device to be controlled listens and processes the IEEE802.11 layer 2 multicast frames.

In some embodiments, provided herein is an apparatus comprising a microprocessor and an IEEE802.11 WLAN chip and the apparatus remotely controls home electronics and other devices by sending IEEE802.11 frames.

In some embodiments, provided herein is an apparatus which remotely controls home electronics and other devices by transmitting IEEE802.11 layer 2 multicast frames.

In some embodiments, provided herein is an apparatus which remotely controls home electronics and other devices by transmitting IEEE802.11 layer 2 multicast frames with unique payload for each remote controller button.

In some embodiments, the apparatus can remotely control more than one home electronics and other devices simultaneously.

In some embodiments, the apparatus comprises a remote controller button capable of transmitting IEEE802.11 layer 2 multicast frames with a unique payload. The device to be controlled is capable of acting based on the content of the payload.

In some embodiments, the apparatus comprises multiple remote controller buttons, each of which when activated transmits IEEE802.11 layer 2 multicast frames with a unique payload. The device to be controlled acts based on the content of the payload. As a result, each remote controller button realizes a unique function in controlling the device.

In some embodiments, the apparatus comprises a microprocessor and an IEEE802.11 WLAN chip, and at least one remote controller button capable of transmitting IEEE802.11 layer 2 multicast frames with a unique payload which can control an electronic device that is capable of acting based on the content of the payload.

### BRIEF DESCRIPTION OF THE DRAWINGS

FIG. 1 is a diagram showing an exemplifying remote controller described herein which uses IEEE802.11 layer 2 multicast frame as signal to control all devices in the range and how it works. The Wi-Fi chips (2, 4) on the home electronic devices (1, 3) operates in a mode such as promiscuous mode or the concurrent AP-STA mode. In this mode, the Wi-Fi chipset listens and passes 802.11 layer 2 multicast frames to the wireless driver in addition to receiving and transmitting unicast data frames and broadcasting management frames. The remote controller (5) transmits 802.11 layer 2 multicast frames with unique payload for each button when button is pressed and the payload does not have a device identifier (id) to specify which devices to control. Therefore, all the devices are controlled simultaneously by the remote controller.

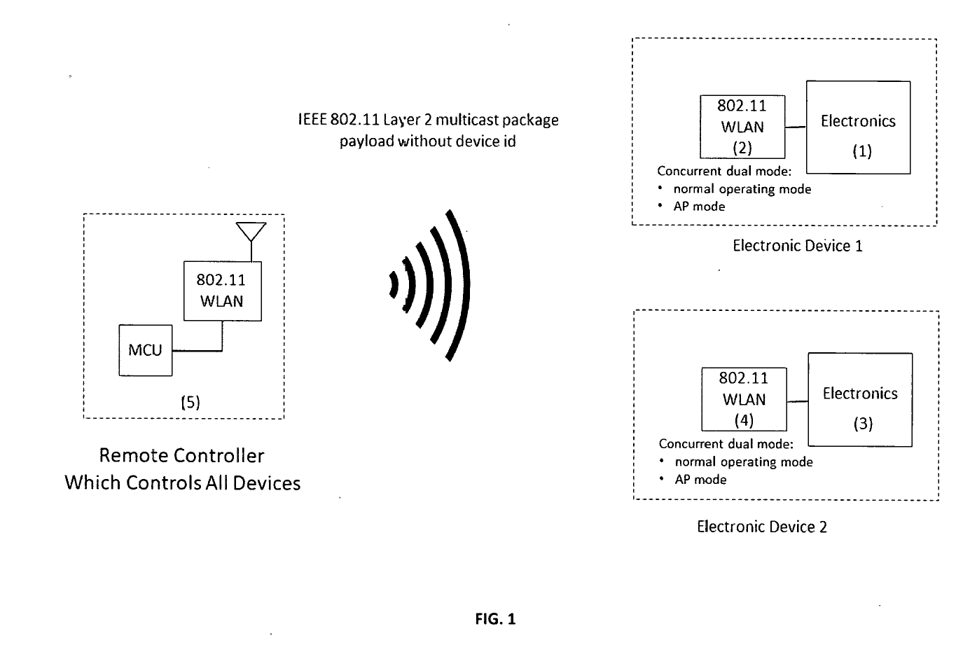

FIG. 2 is a diagram showing an exemplifying a remote controller described herein which uses IEEE802.11 layer 2 multicast frame as signal to that controls only specified devices in the range and how it works. The Wi-Fi chips (2, 4) on the home electronic devices (1, 3) operates in a mode such as promiscuous mode or the concurrent AP-STA mode. In this mode, the Wi-Fi chipset listens and passes 802.11 layer 2 multicast frames to the wireless driver in addition to receiving and transmitting unicast data frames and broadcast management frames. The remote controller (5) transmits 802.11 layer 2 multicast frames with unique payload for each button when button is pressed and the payload has a device id or ids to specify which devices to control. Therefore, only matching devices are controlled by the remote controller.

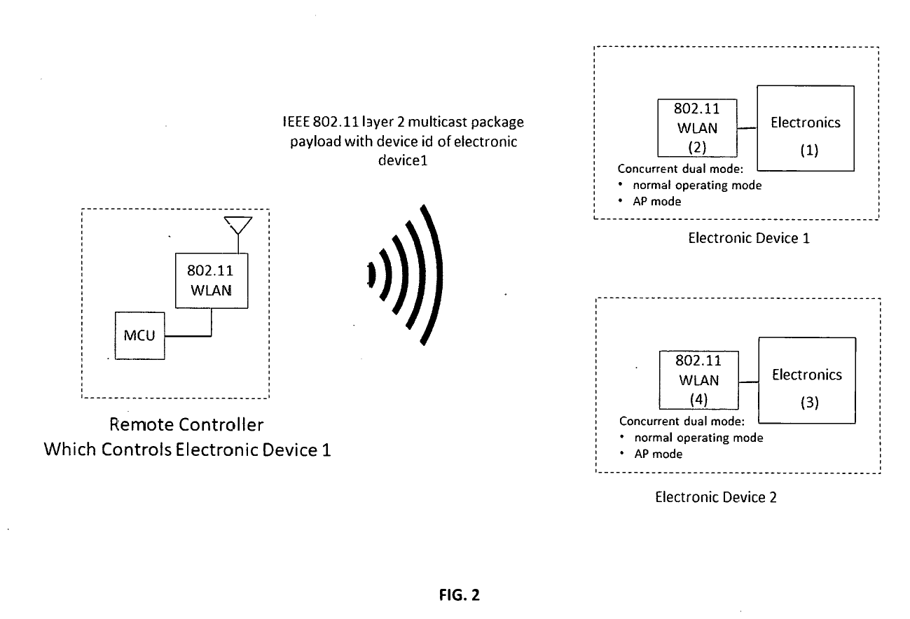

### DETAILED DESCRIPTIONS

802.11 WLAN based remote controllers on today's market usually associate to the wireless routers with which the devices to be controlled are associated. When a button on the remote control is pressed, a TCP or UDP packet is sent to the router and the router relays the message to the device to be controlled. After the device receives the packet, it decodes the content in that TCP or UDP packet and then acts accordingly.

Unlike the other IEEE802.11 WLAN based remote controllers' way of working, the method of remote controlling in present invention is to deliver remote controlling messages by transmitting IEEE802.11 layer 2 multicast packets without establishing wireless connection either directly with the device to be controlled, or with the wireless router with which the device to be controlled is associated.

In the present invention, the remote controller device comprises an IEEE 802.11 WLAN chipset (baseband and RF) and a microcontroller. The IEEE 802.11 WLAN chip and the microcontroller can also be in the form of SoC (system on chip). The remote controller device further comprises one or more buttons, which when pressed activate the remote controller to transmit an IEEE802.11 layer 2 multicast packet. Each of the buttons of the remote controller can be simply mapped to a different GPIO pin of the microcontroller. In this method, a unique payload can be included in the IEEE 802.11 layer 2 multicast packet when a button is pressed.

The remote controller of the present invention doesn't associate to the wireless router or the device to be controlled. Instead, when a button on the remote controller is pressed, it transmits an IEEE 802.11 layer 2 multicast frame with a unique message for that button as payload. Each button on the remote controller has a unique payload message associated with it. When the device to be controlled receives the IEEE 802.11 layer 2 multicast frame, it exams the payload message and acts accordingly. In this way, each button on the remote controller realizes a unique function of the remote controller.

Optionally, the remote controller of the present invention can be configured to append one or more unique id (such as the MAC address) or ids of the devices to be controlled, to the payload. This will allow the remote controller to choose which devices or all devices in the range to control.

The advantages of the remote controller in present invention comparing to other 802.11 WLAN based remote controllers are:
It is more reliable. Since no wireless connections is required, user never needs to worry about connection loss.
It has better latency. The device to be remotely controlled receives the message directly from the remote controller.
It is able to remotely control multiple devices simultaneously.

The remote controller of the present invention requires the device to be remotely controlled be able to receive and process IEEE 802.11 layer 2 multicast packets.

### Exemplifying Implementation

In one example, on the IEEE802.11 WLAN driver of the device to be remotely controlled, make the following implementation:
Configure the WLAN to operate in promiscuous mode if the WLAN chipset supports it so that the WLAN chipset listens and passes 802.11 layer 2 multicast frames to the wireless driver in additional to receive and transmit unicast data frames and broadcast management frames as WLAN station mode normally does. If the WLAN chipset doesn't support promiscuous mode, then in addition to the normal operation mode, implement a concurrent access point mode or to receive and process IEEE802.11 layer 2 multicast packets. Make implementation to let the WLAN driver pass the IEEE802.11 layer 2 multicast packets to application layer. In application layer, make implementation to identify commands from remote control based on payload content of the IEEE802.11 layer 2 multicast packets.

On the remote control side, make the following implementation:
Implement a way to enable use to configure initial setup such as operating channel, which devices to control, and etc.
Implement in the application layer and 802.11 WLAN driver to transmit an IEEE802.11 layer 2 multicast frame in the configured operating channel when trigger by GPIO interrupt.
implement the remote controller to be in sleep mode when not transmitting
Map each button on the remote controller to a different GPIO pin of the microcontroller so that when each different button is pressed, a unique payload is included in the 802.11 layer 2 multicast frame.

What is claimed is:

1. A method of remote controlling an electronic device, wherein a remote controller sends remote controlling messages by transmitting 802.11 layer 2 multicast frames and the device listens and processes the 802.11 layer 2 multicast frames.

2. The method of claim 1, wherein the electronic device is a home electronics or a commercial or industrial device.

3. An apparatus comprising a microprocessor and an IEEE802.11 WLAN chip which apparatus remotely controls an electronic device by sending IEEE 802.11 frames.

4. The apparatus of claim 3, wherein the electronic device is a home electronics or a commercial or industrial device.

5. The apparatus of claim 3 or 4, wherein the apparatus controls an electronic device by transmitting IEEE802.11 layer 2 multicast frames with a unique payload.

6. The apparatus of claim 3 or 4, wherein the apparatus can control more than one electronic devices simultaneously.

7. An apparatus which remotely controls an electronic device by transmitting IEEE802.11 layer 2 multicast frames.

8. The apparatus of claim 7, wherein the electronic device is a home electronic or a commercial or industrial device.

9. The apparatus of claim 3 or 4, wherein the apparatus controls an electronic device by transmitting IEEE802.11 layer 2 multicast frames with a unique payload.

10. The apparatus of claim 7 or 8, wherein the apparatus can control more than one electronic devices simultaneously.

11. An apparatus comprising a plurality of remote controller buttons, which apparatus remotely controls an electronics device by transmitting IEEE802.11 layer 2 multicast frames with a unique payload for each remote controller button.

12. The apparatus of claim 11, wherein the electronic device is a home electronics or a commercial or industrial device.

13. The apparatus of claim 11 or 12, wherein the apparatus controls more than one electronic devices simultaneously.
